(19) United States
(12) Patent Application Publication
(10) Pub. No.: US 2026/0339332 A1
(43) Pub. Date: Oct. 29, 2026

(54) DISTRIBUTED COOPERATIVE SAFETY-CRITICAL CONTROL METHOD FOR MULTI-AGENT SYSTEM

(71) Applicant: Northeastern University, Shenyang (CN)

(72) Inventors: Tengfei LIU, Shenyang (CN); Yuyang PAN, Shenyang (CN); Yuanxiu SHENG, Shenyang (CN); Si WU, Shenyang (CN); Jinliang DING, Shenyang (CN)

(21) Appl. No.: 19/655,627

(22) Filed: Apr. 22, 2026

(30) Foreign Application Priority Data
Apr. 27, 2025 (CN) 202510536783.3

(51) Int. Cl. G05D 1/617; G05D 103/00

(52) U.S. Cl. CPC G05D 1/617; G05D 2103/00

(57) ABSTRACT

A distributed cooperative safety-critical control method for a multi-agent system includes the following steps: S1: establishing a kinematic model of an omnidirectional mobile agent, and generating a nominal velocity command according to a preset trajectory; S2: determining position information of each agent, and broadcasting the position information to other agents; S3: determining a candidate zero-crossing barrier function; S4: generating safety constraints by using the candidate zero-crossing barrier function; S5: determining a loss function based on a nominal velocity, and solving, in a distributed matter, for a control input that minimizes the loss function on the premise that the safety constraints are satisfied, as a safety-critical control command; and S6: controlling a motion of the agent according to the safety-critical control command.

### CROSS-REFERENCE TO RELATED APPLICATIONS

This application claims the benefit and priority to Chinese Patent Application No. 202510536783.3, filed on Apr. 27, 2025. The DAS code for the priority application is DEF2.

### TECHNICAL FIELD

The present invention relates to the technical field of agent safety-critical control, and particularly to a distributed cooperative safety-critical control method for a multi-agent system.

### BACKGROUND OF THE PRESENT INVENTION

Safety means that, in a multi-agent swarm composed of multiple robots, any two agents maintain a sufficiently large distance from each other as much as possible. Safety-critical control is intended to modify a nominal control command as little as possible without violating safety constraints, so that each agent is navigated safely to a specified target point.

With the development of artificial intelligence and robotics, multi-agent systems (MAS) have demonstrated unique advantages in many fields, including formation flight, swarm motion, multi-robot cooperative operation, and the like. These systems are composed of multiple agents with partial perception, communication, computation and actuation capabilities, which are interconnected through networks, and exhibit high autonomy, fault tolerance, cooperativity and flexibility. However, when paths of multiple agents intersect, how to avoid collisions between the agents has become a technical challenge.

After decades of development, numerous safety-critical control methods have been proposed. The methods mainly include global motion planning based on path planning and trajectory optimization, and local motion planning based on reinforcement learning. With respect to the path planning method, a safe path is planned according to environmental information, which may avoid deadlock. However, the method relies on accurate environment perception, demands massive computational resources, and tends to fall into a local optimal solution. With respect to the reinforcement learning method, complex obstacle-avoidance scenarios can be adapted, and there is a potential to achieve an optimal solution. However, the method has drawbacks of high computational resource consumption and limited generalization ability. Control barrier function is a relatively powerful method developed in recent years. As a controller expressed in an optimized form, a system safety-critical controller with a concise structure, simple computation and strong real-time performance is ensured by the method. In recent years, with the widespread application of large-scale robot swarms, relevant research hotspots have begun to focus on the safety-critical control of multi-agent systems. For example, autonomous vehicles need to avoid other vehicles and pedestrians in complex traffic environments; and in cooperative operation of unmanned aerial vehicles and parcel delivery by the unmanned aerial vehicles, collisions must be avoided when paths of multiple unmanned aerial vehicles intersect. In logistics warehouses, multiple transfer robots need to transfer goods efficiently in a space, and the like.

Key issues considered in the safety-critical control of multiple agents include that: each agent only has information about a task thereof but lacks complete knowledge of tasks and states of other agents; and there are couplings among the agents, which means that whether a collision occurs depends not only on a decision thereof but also on decisions of neighboring agents. The safety-critical control of multiple agents mainly adopts a centralized control algorithm and a decentralized control algorithm to solve these two key issues.

With respect to the centralized control algorithm, it is assumed that there is a central node capable of communicating with all agents, and each agent uploads its own state and task information to the central node. The central node computes control commands for all agents in a centralized manner and issues the control commands to all agents. Its advantage is that the central node can obtain global information and make globally optimal decisions. However, in large-scale swarm scenarios covering a large space, no central node can cover all agents due to a limited communication range. Meanwhile, each agent has to upload its state and task information to the central node, and the larger the swarm, the higher the network bandwidth requirement, and the slower the computational speed. With respect to the decentralized control algorithm, a splitting method for coupling constraints is adopted to achieve decoupling. An independent safety-critical controller is deployed on each agent, and this safety-critical controller only computes its own safety-critical control command, thus requiring no task information of other agents. The decentralized control algorithm has the advantages of fast computational speed and easy scalability. However, since the safety-critical controller makes decisions based on local information only, the algorithm is prone to a local optimal solution.

### SUMMARY OF THE PRESENT INVENTION

### Technical Problem to be Solved

In view of the above drawbacks and deficiencies in the prior art, the present invention provides a distributed cooperative safety-critical control method for a multi-agent system, which solves the technical problem about how to avoid collisions between agents while preventing from falling into a local optimal solution.

### Technical Solution

In order to achieve the above objective, the main technical solution used in the present invention is as follows.

In a first aspect, the present invention provides a distributed cooperative safety-critical control method for a multi-agent system, which includes the following steps:
S1: establishing a kinematic model of an omnidirectional mobile agent, and generating a nominal velocity command according to a preset trajectory;
S2: determining position information of each agent, and broadcasting the position information to other agents within a preset range of each agent;
S3: determining a candidate zero-crossing barrier function;
S4: generating safety constraints by using the candidate zero-crossing barrier function based on the kinematic model and relative positions between each agent and all neighboring agents within the preset range of each agent;
S5: determining a loss function based on a nominal velocity, and solving, in a distributed manner, for a control input that minimizes the loss function on the premise that the safety constraints are satisfied, as a safety-critical control command;
S6: controlling a motion of the agent according to the safety-critical control command; and
S7: updating the position of the agent, determining whether all agents reach terminal points, and when all agents do not reach the terminal points, executing step S2; and when all agents reach the terminal points, ending the process.

Optionally, the kinematic model is: \dot{p}ᵢ=uᵢ;
wherein, p is the position of the agent, a two-dimensional column vector pᵢ is used for representing a position of an i^{th} agent in a two-dimensional world coordinate system, and \dot{p}ᵢ is a first-order derivative of the position of the i^{th} agent; and u is a linear velocity of the agent, which is also a control input of the system, and a two-dimensional column vector uᵢ is used for representing a velocity of the i^{th} agent in the two-dimensional coordinate system.

Optionally, the zero-crossing barrier function h is:

h(pᵢ(tₖ)−pⱼ(tₖ))=∥pᵢ(tₖ)−pⱼ(tₖ)∥₂−Dₛ;
wherein, Dₛ=D₀+Rₛ is a constant, D₀ is an expected safe distance between two agents, Rₛ is a safety margin added to ensure robustness, i,j∈1, . . . , N, i≠j, N is a total number of agents in a swarm, a symbol ∥⋅∥₂ represents a two-norm of a vector, and pⱼ represents a position of a j^{th} agent;

Optionally, the generating the safety constraints based on the candidate zero-crossing barrier function, includes:
differentiating the zero-crossing barrier function with respect to time t to obtain a safety constraint g as follows:

$${g}_{ij} ( {t}_{k} ) = \frac{{( {p}_{i} ( {t}_{k} ) - {p}_{j} ( {t}_{k} ) )}^{T}}{{‖ {p}_{i} ( {t}_{k} ) - {p}_{j} ( {t}_{k} ) ‖}_{2}} ( {u}_{i} - {u}_{j} ) + γ ( h ( {p}_{i} ( {t}_{k} ) - {p}_{j} ( {t}_{k} ) ) ) \geq 0 ;$$

wherein, γ is a decay rate of the barrier function, which is a constant greater than 0; and tₖ is sampling time, and u is the control input, u={u₁, u₂, . . . u_{N}}.

Optionally, the loss function is:

$$f ( u ) = {\sum }_{i = 1}^{N} {‖ {u}_{i} - {v}_{i}^{*} ( {t}_{k} ) ‖}^{2} ;$$

wherein, vᵢ*∈ [symbol] ² is a nominal control input, which provides a reference value of velocity for the i^{th} agent.

In a second aspect, the present invention provides a computer-readable storage medium, storing a computer program, wherein the program, when executed, implements the distributed cooperative safety-critical control method for the multi-agent system in the first aspect above.

In a third aspect, the present invention provides a storage device, including a storage medium and a processor, the storage medium storing a computer program, wherein the program, when executed by the processor, implements the distributed cooperative safety-critical control method for the multi-agent system in the first aspect above.

### Beneficial Effects

Beneficial effects of the present invention: compared with the prior art, the distributed cooperative safety-critical control method for the multi-agent system of the present invention has the following prominent advantages.

The method proposed by the present invention enables each agent to take into account decision-making information of the neighboring agents by a distributed optimization algorithm, so as to realize cooperative obstacle avoidance. The method not only avoids collisions between the agents, but also effectively solves the problems of local optimal solution caused by a decentralized safety-critical controller only relying on local information, thereby ensuring the optimality of global path planning.

According to the present invention, the safety-critical controller is distributed on each agent, and each agent only needs to communicate with the neighboring agents through a local area network, which solves the problem of limited communication range. Moreover, the method alleviates the problem of insufficient network bandwidth caused by collecting information of all agents and the problem of slow computational speed caused by solving for safety constraints of all robots in a swarm when a centralized controller is used for safety-critical control of large-scale robot swarm.

By broadcasting the predicted position information over a prediction horizon of length t, the agent shares a motion intention with the neighboring agents in advance, which reduces a position error generated by the motion of the agent during computation. Meanwhile, the additional safety margin is introduced to compensate for a position prediction error and a calculation error caused by a network delay. This mechanism not only solves the problem of clock asynchrony in the multi-agent system due to the network delay, but also ensures that the cooperative obstacle avoidance between the agents can be carried out safely and effectively even under discontinuous computation, thereby significantly improving the obstacle avoidance robustness of the multi-agent system in complex environments.

### BRIEF DESCRIPTION OF THE DRAWINGS

FIG. 1 is a block diagram of a control system provided by an embodiment of the present invention;

FIG. 2 is a schematic diagram of an initial simulation state provided by the embodiment of the present invention;

FIG. 3 is a schematic diagram of simulation results of a decentralized safety-critical controller provided by the embodiment of the present invention;

FIG. 4 is a schematic diagram of simulation results of a distributed safety-critical controller provided by the embodiment of the present invention;

FIG. 5 is a schematic diagram of simulation results of a centralized safety-critical controller provided by the embodiment of the present invention;

FIG. 6 shows a physical experiment platform for feasibility provided by the embodiment of the present invention;

FIG. 7 is a diagram of physical experiment results provided by the embodiment of the present invention; and

FIG. 8 is a flow chart of a distributed cooperative safety-critical control method for a multi-agent system provided by the embodiment of the present invention.

### DETAILED DESCRIPTION OF PREFERRED EMBODIMENTS

For better explanation of the present invention to facilitate understanding, the present invention is described in detail hereinafter with reference to the drawings through specific embodiments.

In view of the safety requirements of omnidirectional mobile robots performing tasks in large-scale robot swarm scenarios, the present invention designs a distributed cooperative safety-critical control method for a multi-agent system. On one hand, any agent in a swarm only knows a control objective thereof; and on the other hand, the agent can only communicate with neighboring agents, without a central node capable of obtaining global information. An objective of the method is that the agent avoids collisions with other agents and reaches a target position based only on information thereof and information of the neighboring agents. A key feature of the method is that, during real-time interaction among the agents, states of any two agents in the swarm can always be guaranteed to remain within a safety set. Furthermore, on the premise that the agent does not possess global information, the agent communicates with the neighboring agents to modify a nominal control command as little as possible, thereby completing respective task objectives.

According to the method, by constructing a robust control barrier function and generating safety constraints, a safety-critical control problem is formulated as a quadratic programming problem with several linear inequality constraints, and a distributed optimization algorithm is introduced for solution. In the present invention, aiming at the problems of lack of global information and coupling constraint among the agents in the multi-agent system, several important improvements are made in the present invention. Firstly, by designing a candidate zero-crossing barrier function and constructing the safety constraints, the agent is ensured to be safe with respect to every neighboring agent; secondly, the safety-critical control problem is transformed into the quadratic programming problem to optimize a control input while satisfying all safety constraints; and finally, a distributed optimization algorithm is introduced to implement distributed iterative solution of the quadratic programming problem on each agent, thereby avoiding the problems of limited communication range of the central node and insufficient network bandwidth. These three improvements enable effective collision avoidance among the agents in a large-scale agent swarm even in the absence of the global information and the central node, and ensure safe navigation of the agent to a specified target point.

For better understanding of the above technical solution, exemplary embodiments of the present invention will be described in more detail hereinafter with reference to the drawings. Although the exemplary embodiments of the present invention are shown in the drawings, it should be understood that the present invention may be embodied in many different forms and shall not be construed as being limited to the embodiments set forth herein. Rather, these embodiments are provided, so that the present invention can be understood clearly and thoroughly, and can fully convey the scope of the present invention to those skilled in the art.

The controlled object considered in the embodiment is a multi-agent system composed of N agents with omnidirectional motion capability, which is illustrated herein by an unmanned vehicle equipped with Mecanum wheels and capable of realizing an omnidirectional motion. A kinematic model of the agent may be represented by a first-order integrator model: \dot{p}ᵢ=uᵢ;
wherein, p is the position of the agent, a two-dimensional column vector pᵢ is used for representing a position of an i^{th} agent in a two-dimensional world coordinate system, and P; is a first-order derivative of the position of the i^{th} agent; and u is a linear velocity of the agent, which is also a control input of the system, and a two-dimensional column vector uᵢ is used for representing a velocity of the i^{th} agent in the two-dimensional coordinate system.

Furthermore, a bounded nominal velocity v* that is uncertified for safety is obtained by a path-tracking algorithm. A distributed safety-critical controller designed in the embodiment is used to carry out safety filtering on the nominal velocity, and an output safety-critical control command is sent to a motion controller to finally drive the agent to move, so that the agent reaches the target point without colliding with other agents.

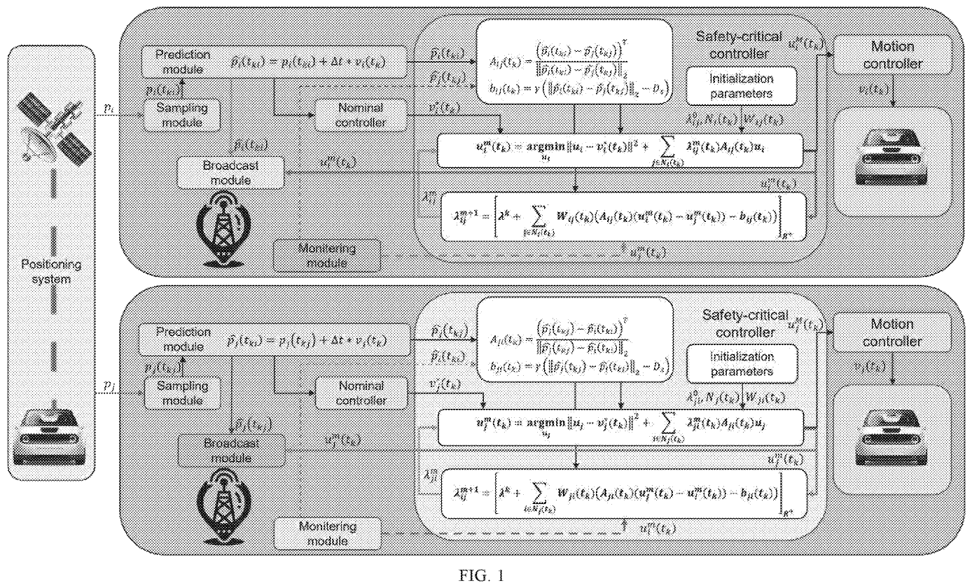

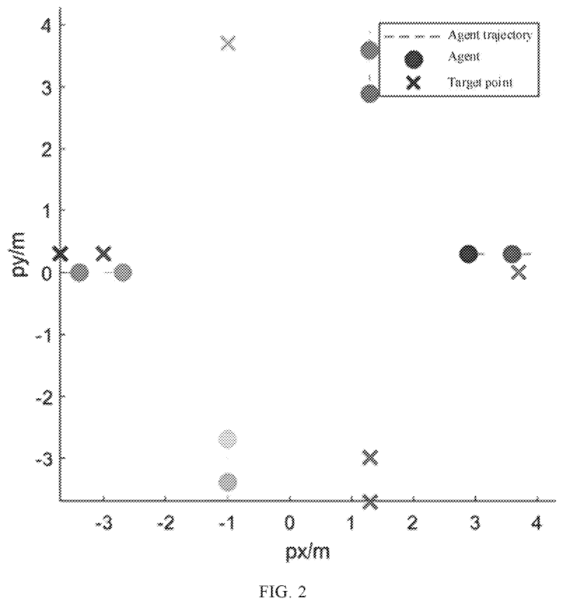

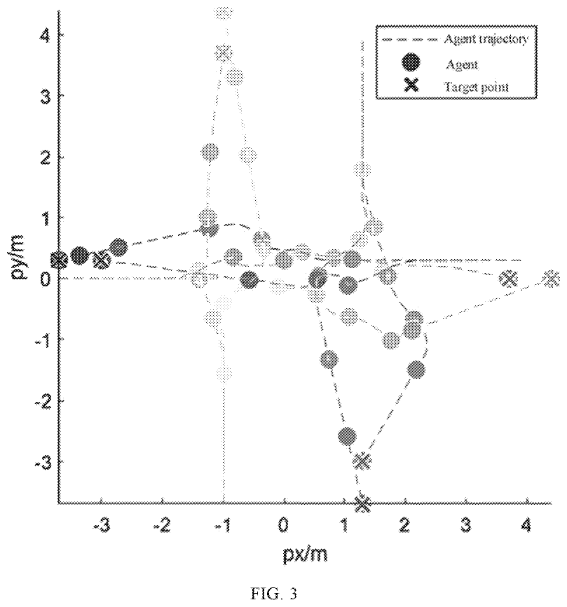

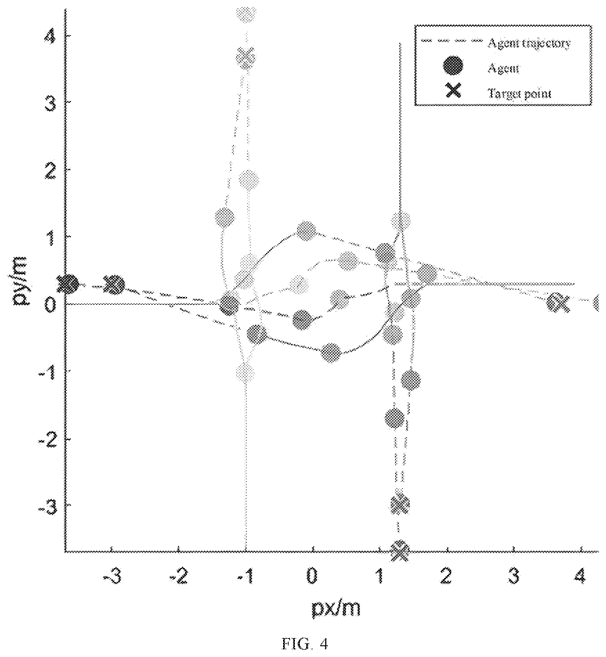

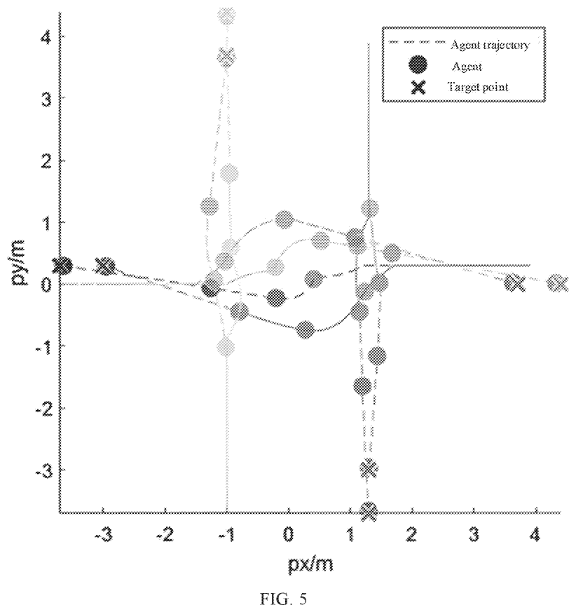

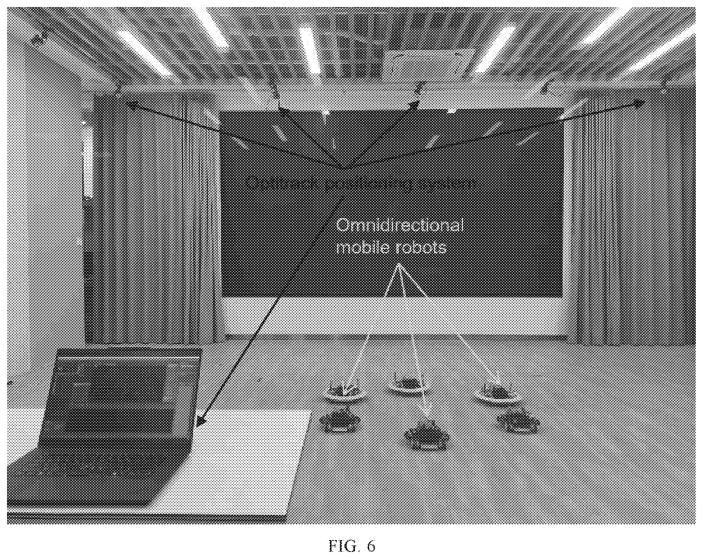

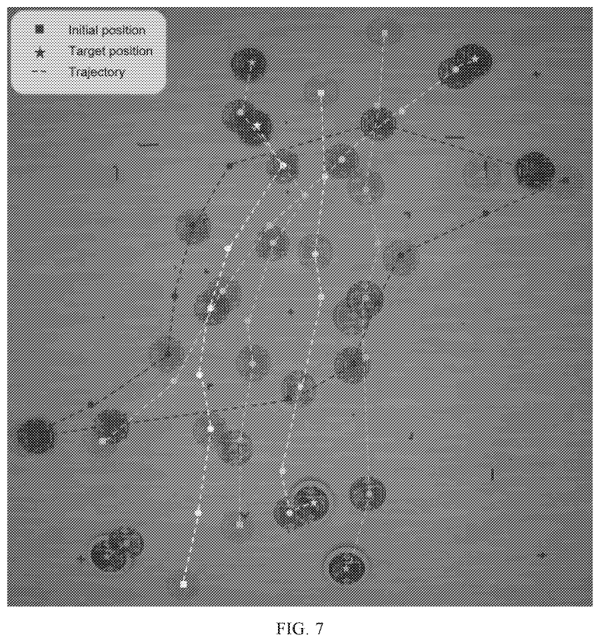

FIG. 1 shows an overall algorithm framework of the method provided in the embodiment. FIG. 2, FIG. 3, FIG. 4 and FIG. 5 show comparison of Matlab simulation results between controllers designed based on the algorithm in the embodiment and the decentralized algorithm. FIG. 6 shows a physical experimental system of the algorithm. The physical experimental system includes a motion capture system Optitrack and several omnidirectional mobile robots equipped with Raspberry Pi. All devices are connected to the same local area network through wireless network cards or cables, and a ROS-based distributed communication framework is used to enable information exchange among devices. FIG. 7 shows physical experimental results of the algorithm.

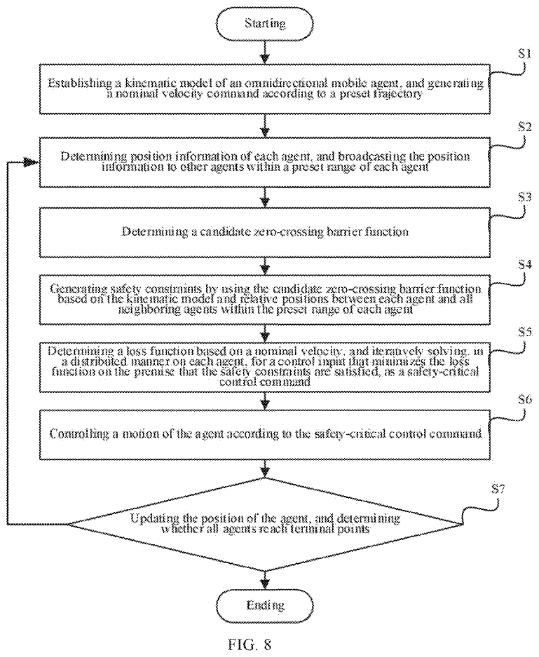

In a first aspect, with reference to FIG. 8, the present invention provides a distributed cooperative safety-critical control method for a multi-agent system, which includes the following steps.

In S1, a kinematic model of an omnidirectional mobile agent is established, and a nominal velocity command is generated according to a preset trajectory.

In S2, position information of each agent is determined, and broadcast to other agents within a preset range of each agent.

Assuming that all agents in a swarm have the same control period Δt=tₖ−tₖ₋₁, Δt is greater than time required for the agent to solve a quadratic programming problem in a distributed manner. At time tₖ₋₁, the agent samples position information p_{i,real}(tₖ₋₁) thereof through a motion capture system, predicts position information thereof after Δt based on current velocity thereof, which is recorded as pᵢ(tₖ)=p_{i,real}(tₖ₋₁)+Δt×vᵢ(tₖ₋₁), wherein vᵢ(tₖ₋₁) is a control input actually executed by an agent i within a current control period t∈(tₖ₋₁, tₖ). The agent stores the information pᵢ(tₖ) within the control period, broadcasts the information to neighboring agents, and obtains sampled position information pⱼ(tₖ) broadcast by the neighboring agents.

In S3, a candidate zero-crossing barrier function is determined.

h(pᵢ(tₖ)−pⱼ(tₖ))=∥pᵢ(tₖ)−pⱼ(tₖ)∥₂−Dₛ;
wherein, Dₛ=D₀+Rₛ, i,j∈1, . . . , N, i≠j.

D₀ is an expected safe distance between two agents, which is generally a sum of radii of expansion circles of the agent i and the agent j.

Rₛ is an additional safety margin, which can compensate for the effects of a position prediction error and a calculation error on system safety. The prediction error is defined as follows: Eₚ_{ᵢ}=p_{i,real}(tₖ)−pᵢ(tₖ). The prediction error may be regarded as a sensor measurement error, and the calculation error caused by finite-step iteration may be regarded as an actuator error. Existing studies in related fields have demonstrated that, for a sampled-data system with the measurement error and the actuator error, the additional safety margin may ensure that the application of the safety-critical control input can still guarantee that the state remains within a safe set. Therefore, in the present patent, the additional safety margin Rₛ is used to compensate for the prediction deviation of the position information of the agent and the calculation error, and the control input is generated, so that it is still possible to ensure that the system state strictly satisfies forward invariance.

In S4, safety constraints are generated by using the candidate zero-crossing barrier function based on the kinematic model and relative positions between each agent and all neighboring agents within the preset range of each agent.

Based on a relative distance between two different agents, the candidate zero-crossing barrier function h(pᵢ(tₖ)−pⱼ(tₖ)) is designed, and the safety constraints are constructed to ensure that the agent is safe with respect to every neighboring agent.

Based on a theory of a control barrier function, h(pᵢ(tₖ)−pⱼ(tₖ)) is differentiated with respect to time t to obtain one safety constraint.

This constraint restricts the control input of the agent to ensure that no collision occurs between the agents, thereby defining a control strategy set satisfying safety conditions. Generally, in order to ensure that no collision occurs between any two agents in the multi-agent system, the same form of safety constraint must be imposed on every pairwise combination of all agents.

gᵢⱼ(tₖ)≥0i,j∈1, . . . ,N,i≠j

Therefore, a number of constraints can increase sharply, and a solution speed of optimization problem is reduced, resulting in poor real-time performance of algorithm. In addition, the construction of safety constraints among all agents requires global position information of the agents, which is likely infeasible in consideration of practical communication range and bandwidth limitation. Aiming at the above problem, the present invention provides a solution in S5.

In S5, a loss function is determined based on a nominal velocity, and a control input that minimizes the loss function on the premise that the safety constraints are satisfied, is solved for in a distributed manner, as a safety-critical control command.

A control objective of a safety-critical control problem of the multi-agent swarm is to minimally modify the nominal control command while ensuring that no collision occurs between any two agents in the swarm. Therefore, a quadratic cost function may be used to compensate for a deviation between the control input and a nominal control input, and the safety constraints are used as hard constraints in the optimization problem, so that the safety-critical control problem is formulated as a quadratic programming problem with multiple linear inequality constraints, which is a convex optimization problem.

Considering that the safety-critical control problem is a local problem, which means that, when the agents are far away from each other, dynamic behaviors of the agents may not be concerned, when the safety constraints between sufficiently distant agents are ignored, the above safety-critical controller remains valid. Meanwhile, considering that solving time of the multi-agent safety-critical controller cannot be ignored, the controller may be modified as follows:

$$[ {v}_{1} ( {t}_{k} ) , … , {v}_{N} ( {t}_{k} ) ] = {arg min}_{u} {\sum }_{i = 1}^{N} {‖ {u}_{i} - {v}_{i}^{*} ( {t}_{k} ) ‖}^{2} ;$$

$$s . t . \frac{{( {p}_{i} ( {t}_{k} ) - {p}_{j} ( {t}_{k} ) )}^{T}}{{‖ {p}_{i} ( {t}_{k} ) - {p}_{j} ( {t}_{k} ) ‖}_{2}} ( {u}_{i} - {u}_{j} ) + γ ( {‖ {p}_{i} ( {t}_{k} ) - {p}_{j} ( {t}_{k} ) ‖}_{2} - {D}_{s} ) \geq 0 ;$$

$$i ∈ 1 , … , N , j ∈ {N}_{i} ( {t}_{k} ) .$$

Nᵢ(tₖ) represents a set of other agents within a neighborhood of the agent at the sampling time tₖ, which is defined as follows:

$${N}_{i} ( {t}_{k} ) = \{ j \neq i ∈ 1 , … , N : {‖ {p}_{i} ( {t}_{k} ) - {p}_{j} ( {t}_{k} ) ‖}_{2} \leq {D}_{s} + \frac{2 * {v}_{max}}{γ} \} ;$$

wherein, vₘₐₓ is an upper velocity limit of the agent, and γ is a constant greater than 0 as defined in the step 2.

It is straightforward to see that an original quadratic programming problem has coupled linear constraints, which means that a decision of the agent i depends on the decisions of neighboring agent j. In this way, an algebraic loop is generated, so that the controller cannot be deployed in a distributed manner directly.

A quadratic coefficient matrix of the original quadratic programming problem is positive definite, and all constraints are linear inequalities. Therefore, the original quadratic programming problem is a convex optimization problem. By the strong duality principle, the dual problem of the original quadratic programming problem may be solved instead:

$${max}_{λ} d ( λ ) = {max}_{λ} {min}_{u} L ( u , λ ) ;$$

$$s . t . {λ}_{ij} \geq 0 ( {λ}_{ij} ∈ λ ) ;$$

wherein, λᵢⱼ is a Lagrange multiplier corresponding to a constraint gᵢⱼ, λ={λᵢⱼ|i≠j∈1, . . . , N}, and L(u,λ) is a Lagrangian function of the original quadratic programming problem, which is defined as follows:

$$L ( u , λ ) = {\sum }_{i = 1}^{N} ( {‖ {u}_{i} - {v}_{i}^{*} ( {t}_{k} ) ‖}^{2} + {\sum }_{j ∈ {N}_{i} ( {t}_{k} )} {λ}_{ij} ( {t}_{k} ) {g}_{ij} ( {t}_{k} ) ) .$$

The Lagrangian function contains two sets of variables, u is the control input, and λ is the constraint variable. The inner-layer control input u is solved for, and then the outer-layer constraint variable is updated by a gradient ascent method.

A specific method for solving the dual problem is given as follows.
1. An initial value λ⁰ of the constraint variable is initialized, and an inner-layer control input

$${u}_{i}^{m} ( {t}_{k} )$$

i∈1, . . . , N is solved for;

$${u}_{i}^{m} ( {t}_{k} ) = {arg min}_{{u}_{i}} {‖ {u}_{i} - {v}_{i}^{*} ( {t}_{k} ) ‖}^{2} + {\sum }_{j ∈ {N}_{i}} {λ}_{ij}^{m} ( {t}_{k} ) {A}_{ij} ( {t}_{k} ) {u}_{i} m = 0 , … , M .$$

2. An outer-layer constraint variable

$${λ}_{ij}^{m + 1}$$

i≠j∈1, . . . , N is updated by the gradient ascent method;

$${λ}_{ij}^{m + 1} ( {t}_{k} ) = {[ {λ}_{ij}^{m} ( {t}_{k} ) + \frac{1}{{W}_{ij} ( {t}_{k} )} ( {A}_{ij} ( {t}_{k} ) {u}_{i}^{m} ( {t}_{k} ) + {A}_{ji} ( {t}_{k} ) {u}_{j}^{m} ( {t}_{k} ) - {b}_{ij} ( {t}_{k} ) ) ]}_{{R}^{+}} ,$$

wherein, Wᵢⱼ(tₖ) depends on numbers Nᵢ(tₖ) and Nⱼ(tₖ) of other agents within neighborhoods of the agents i and j at the time tₖ, and is defined as follows: Wᵢⱼ(tₖ)=Nᵢ(tₖ)+Nⱼ(tₖ).
3.

$${v}_{i} ( {t}_{k} ) = {u}_{i}^{M} ( {t}_{k} )$$

is set, wherein M is a maximum number of iterations limited by a network communication delay.

The agent i updates control input ui and relevant constraint variable λᵢⱼ(j∈Nᵢ) thereof locally.

When iteratively updating the relevant constraint variable

$$( {λ}_{ij}^{m} ( {t}_{k} ) , j ∈ {N}_{i} )$$

thereof locally, the agent i only requires a local iteration result

$${u}_{i}^{m - 1} ( {t}_{k} )$$

from the previous iteration round and an iteration result

$${u}_{j}^{m - 1} ( {t}_{k} )$$

of the neighboring agent. When computing the local control input

$${u}_{i}^{m} ( {t}_{k} ) ,$$

the agent only requires the local constraint variable (λᵢⱼ^{m}(tₗ), j∈Nᵢ). Therefore, a method for solving the dual problem is a distributed manner.

It should be noted that λᵢⱼ and λⱼᵢ correspond to the same constraint. Although the variables are iterated on the agent i and the agent j respectively, the variables have the same iteration formula, so that

$${λ}_{ij}^{m} ( {t}_{k} ) ≡ {λ}_{ji}^{m} ( {t}_{k} ) .$$

In S6, a motion of the agent is controlled according to the safety-critical control command.

In S7, the position of the agent is updated, whether all agents reach terminal points is determined, and when all agents do not reach the terminal points, the step S2 is executed; and when all agents reach the terminal points, the process is ended.

Optionally, the kinematic model is: \dot{p}ᵢ=uᵢ; and
wherein, p is the position of the agent, a two-dimensional column vector pᵢ is used for representing a position of an i^{th} agent in a two-dimensional world coordinate system, and \dot{p}ᵢ is a first-order derivative of the position of the i^{th} agent; and u is a linear velocity of the agent, which is also a control input of the system, and a two-dimensional column vector uᵢ is used for representing a velocity of the i^{th} agent in the two-dimensional coordinate system.

Optionally, the zero-crossing barrier function h is:

h(pᵢ(tₖ)−pⱼ(tₖ))=∥pᵢ(tₖ)−pⱼ(tₖ)∥₂−Dₛ;
wherein, Dₛ=D₀+Rₛ is a constant, D₀ is an expected safe distance between two agents, Rs is a safety margin added to ensure robustness, i,j∈1, . . . , N, i≠j, N is a total number of agents in a swarm, a symbol ∥⋅∥₂ represents a two-norm of a vector, and pⱼ represents a position of a j^{th} agent;

Optionally, the generating the safety constraints based on the candidate zero-crossing barrier function, includes:
differentiating the zero-crossing barrier function with respect to time t to obtain a safety constraint g as follows:

$${g}_{ij} ( {t}_{k} ) = \frac{{( {p}_{i} ( {t}_{k} ) - {p}_{j} ( {t}_{k} ) )}^{T}}{{‖ {p}_{i} ( {t}_{k} ) - {p}_{j} ( {t}_{k} ) ‖}_{2}} ( {u}_{i} - {u}_{j} ) + γ ( h ( {p}_{i} ( {t}_{k} ) - {p}_{j} ( {t}_{k} ) ) ) \geq 0 ;$$

wherein, γ is a decay rate of the barrier function, which is a constant greater than 0; and tₖ is sampling time, and u is the control input.

Optionally, the loss function is:

$$f ( u ) = {\sum }_{i = 1}^{N} {‖ {u}_{i} - {v}_{i}^{*} ( {t}_{k} ) ‖}^{2} ;$$

wherein,

$${v}_{i}^{*}$$

∈ [symbol] ² is a nominal control input, which provides a reference value of velocity for the i^{th} agent, pᵢ* represents a terminal point of the i^{th} agent, and vᵢ∈ [symbol] ² is an actually output control input.

Optionally, the control input is obtained by solving the loss function combined with a distributed optimization algorithm, which includes:
solving for the inner-layer control input u of the loss function based on the Lagrangian function, and updating the outer-layer constraint variable/by the gradient ascent method.

The distributed safety-critical control method designed in the present invention has the following characteristics.

Different from traditional safety-critical control methods, the distributed safety-critical controller does not rely on a sensor thereof to sense the position information of the neighboring agents. Instead, the controller broadcasts position information thereof to the neighboring agents and simultaneously receives the position information broadcast by the neighboring agents. This method ensures that different agents can jointly handle the same problem even when clocks of the agents are not synchronized.

By deploying the above distributed controller on each agent, each agent solves a safety-critical control command thereof by using local information, which guarantees the safety of the multi-agent system. Furthermore, a safety-critical control decision made by the control method based on the local information of each agent is globally optimal.

An input of the control method is information of the neighboring agents. Even for a large-scale agent swarm in a large-scale scenario, a single agent only needs the information of the neighboring agents, which greatly reduces network bandwidth requirements and reduces a computational burden, and is applicable to a scenario without a central node at the same time.

It should be noted that, in the method proposed by the present invention, when the agent calculates a local safety problem within the neighborhood thereof, the calculation is completed entirely based on local information without acquiring the global position information of all agents.

Specifically, each agent i broadcasts position information thereof and receives information pᵢ(tₖ) broadcast by the neighboring agents, and can only obtain positions of neighboring agents communicating directly with said agent. A definition of a neighborhood set Nᵢ(tₖ) depends on a relative distance between agents, and the construction of the neighborhood set relies only on position information of local agents, requires no knowledge of all agents, and is fully implemented locally on the agent.

In the present invention, the distributed optimization algorithm is adopted to ensure that, when the agent solves the local optimization problem locally, the iteration is carried out only based on the decision information of the agents within the neighborhood, rather than the decision information of all agents in the swarm, so as to guarantee a fully distributed nature of the safety-critical control method proposed by the present invention.

This processing flow is consistent with a core feature of “distributed cooperative” of the present invention, which means that each agent completes safety-critical control only through local interaction, which avoids reliance on centralized global information, thereby solving the problems of limited communication range and insufficient network bandwidth.

In the present invention, a multi-agent collision avoidance problem in which 8 omnidirectional Mecanum-wheel carts with kinematic models approximated as first-order integrators are selected to reach their respective target points in a site while avoiding a collision with each other is taken as another embodiment, which is described in detail with reference to FIG. 2, FIG. 3, FIG. 4 and FIG. 5 as follows:

In a simulation environment, 8 circular agents with a radius of 0.15 m are considered. Simulation time is t∈[0,20], and initial time is t₀=0 s. An initial position pᵢ(0) and a task target point

$${p}_{i}^{*}$$

of each agent are configured as shown in Table 1.

TABLE 1

| | | | | | | | |
|---|---|---|---|---|---|---|---|
| p₁^{*}/m | (−3.7,0.3) | p₂^{*}/m | (−3.0,0.3) | p₃^{*}/m | (1.3,−3.7) | p₄^{*}/m | (1.3,−3.0) |
| p₅^{*}/m | (3.7,0.0) | p₆^{*}/m | (4.4,0.0) | p₇^{*}/m | (−1.0,3.7) | p₈^{*}/m | (−1.0,4.4) |
| p₁(0)/m | (3.2,0.3) | p₂(0)/m | (3.9,0.3) | p₃(0)/m | (1.3,3.2) | p₄(0)/m | (1.3,3.9) |
| p₅(0)/m | (−3.7,0.0) | p₆(0)/m | (−3.0,0.0) | p₇(0)/m | (−1,-3.7) | p₈(0)/m | (−1,−3.0) |

A nominal controller

$${v}_{i}^{*} ( {t}_{k} ) = {K}_{p}^{*} ( {p}_{i}^{*} - {p}_{i} ( {t}_{k} ) )$$

for the agent is defined. A state of the agent is updated by using pᵢ(t+T)=pᵢ(t)+vᵢ(t)*T, wherein T is a simulation step size.

Controller parameters of a simulation experiment of distributed safety-critical control are shown in Table 2 below.

TABLE 2

| Experimental | | | |
|---|---|---|---|
| parameter | Parameter description | Parameter value | |
| Kₚ | Nominal controller gain | 0.8 | |
| γ | Decay rate | 2.0 | |
| D₀ | Safety distance | 0.3 | m |
| Rₛ | Safety margin | 0.2 | m |
| vₘₐₓ | Maximum velocity of agent | 1.0 | m/s |
| T | Simulation step size | 0.01 | s |
| Δt | Control period | 0.20 | s |

| | | |
|---|---|---|
| M | Maximum number of iterations | 10 |

Under the same initial conditions, the distributed safety-critical controller proposed in the present invention, and existing centralized safety-critical controller and decentralized safety-critical controller, are applied to the multi-agent system respectively, and motion trajectories of each agent are shown in FIG. 2, FIG. 3, FIG. 4 and FIG. 5. Simulation results show that, for ∀t∈[0,20], a relative distance between any two agents i and j in the swarm satisfies ∇pᵢⱼ(t)=(pᵢ(t)−pⱼ(t))≥D₀. In the swarm, minimum inter-agent distances of the decentralized safety-critical controller, the centralized safety-critical controller and the distributed safety-critical controller in the embodiment are 0.5014 m, 0.5915 m and 0.5252 m respectively. Although the inter-agent distance of the distributed safety-critical controller is slightly lower than that of the centralized scheme due to a sampling error and an iterative computation error, an actual safety distance still strictly meets system requirements by adding the safety margin, thereby ensuring the safety of the multi-agent system, which indicates that the designed distributed controller can effectively coordinate the local constraints while avoiding dependence on the global information, thereby achieving safety performance close to that of the centralized scheme.

Under the same simulation time and parameters, agent swarms deployed with the decentralized safety-critical controller, the centralized safety-critical controller, and the distributed safety-critical controller designed in the present invention take 13.45 seconds, 9.44 seconds and 9.40 seconds to reach the task target points respectively, which is because safety-critical control decisions made by the agents deployed with the distributed safety-critical controller and the centralized safety-critical controller are both globally optimal, whereas the agent deployed with the decentralized safety-critical controller only makes a local optimal decision based on local information thereof, resulting in a more conservative safety-critical control command and longer time to reach the target point.

In order to further verify the implementation feasibility of the algorithm designed in the present invention, a physical experiment is carried out on a physical experimental platform shown in FIG. 6, and experimental results are shown in FIG. 7.

The distributed safety-critical controller proposed in the present invention is deployed on a Raspberry Pi development board of each agent, and each agent constructs a local safety problem locally according to position information of said agent and neighboring agents, and a nominal velocity of said agent, and iteratively solves the problem locally by a Lagrangian relaxation method. In an m^{th} iteration, an agent i calculates a Lagrange multiplier

$${λ}_{ij}^{m}$$

for a current iteration round by using a result

$${u}_{i}^{m - 1}$$

of an (m−1)^{th} iteration and an iteration result

$${u}_{j}^{m - 1}$$

of a neighboring agent, updates a result

$${u}_{i}^{m}$$

of the m^{th} iteration by using the

$${λ}_{ij ,}^{m}$$

and then broadcasts the

$${u}_{i}^{m}$$

to the neighboring agent. A result

$${u}_{i}^{M}$$

of an M^{th} iteration is taken as an actual velocity command vᵢ of the agent at current time.

Finally, a safety-critical control command output by the safety-critical controller (deployed on the Raspberry Pi) is sent to the motion controller (deployed on an underlying development board) through a serial port to drive the agent to move. Through this process, the position of the agent is changed, thereby completing the safety-critical control at the current time.

The physical experimental results show that the agents are navigated by the distributed safety-critical controller in the embodiment to move from starting points along preset paths, and when there are conflicts among preset paths of multiple agents, the agents coordinate with each other to complete obstacle avoidance and finally reach their respective target positions safely. The safety decisions made are globally optimal, thereby avoiding a deadlock problem of the safety-critical controller when there are conflicts among paths of multiple agents.

In a second aspect, the embodiment of the present invention provides a computer-readable storage medium, storing a computer program, wherein the program, when executed, implements the distributed cooperative safety-critical control method for the multi-agent system in the first aspect above.

In a third aspect, the embodiment of the present invention provides a storage device, including a storage medium and a processor, the storage medium storing a computer program, wherein the program, when executed by the processor, implements the distributed cooperative safety-critical control method for the multi-agent system in the first aspect above.

Those skilled in the art shall understand that the embodiments of the present invention may be provided as methods, systems or computer program products. Therefore, the present invention may take the form of complete hardware embodiment, complete software embodiment or software-hardware combined embodiment. Moreover, the present invention may take the form of computer program product implemented on one or more computer usable storage media (including, but being not limited to, a disk memory, a CD-ROM, an optical memory, etc.) in which computer usable program codes are included.

Obviously, those skilled in the art may make various modifications and variations to the present invention without departing from the spirit and scope of the present invention. Therefore, if these modifications and variations of the present invention fall within the scope of the claims of the present invention and their equivalents, the present invention is also intended to include these modifications and variations.

Although the embodiments of the present invention have been shown and described above, it may be understood that the above embodiments are exemplary and cannot be understood as limiting the present invention, and those of ordinary skills in the art may make changes, modifications, substitutions and variations to the above embodiments within the scope of the present invention.

We claim:

1. A distributed cooperative safety-critical control method for a multi-agent system, comprising the following steps:
S1: establishing a kinematic model of an omnidirectional mobile agent, and generating a nominal velocity command according to a preset trajectory;
S2: determining position information of each agent, and broadcasting the position information to other agents within a preset range of each agent;
S3: determining a candidate zero-crossing barrier function;
S4: generating safety constraints by using the candidate zero-crossing barrier function based on the kinematic model and relative positions between each agent and all neighboring agents within the preset range of each agent;
S5: determining a loss function based on a nominal velocity, and iteratively solving, in a distributed manner on each agent, for a control input that minimizes the loss function on the premise that the safety constraints are satisfied, as a safety-critical control command;
wherein, each agent constructs a local safety problem locally according to position information of said agent and neighboring agents, and a nominal velocity of said agent, and iteratively solves the local safety problem locally by a Lagrangian relaxation method; and in an m^{th} iteration, an agent i calculates a Lagrange multiplier
$${Λ}_{ij}^{m}$$
for a current iteration round by using a result
$${u}_{i}^{m - 1}$$
of an (m−1)^{th} iteration and an iteration result
$${u}_{j}^{m - 1}$$
of a neighboring agent, using a result
$${u}_{i}^{m}$$
of the m^{th} iteration by using the
$${λ}_{ij}^{m} ,$$
and then broadcasts the
$${u}_{i}^{m}$$
to the neighboring agent;
S6: controlling a motion of the agent according to the safety-critical control command; and
S7: updating the position of the agent, determining whether all agents reach terminal points, and when all agents do not reach the terminal points, executing step S2; and when all agents reach the terminal points, ending the process;
wherein, the kinematic model is:
\dot{p}ᵢ=uᵢ;
wherein, p is the position of the agent, a two-dimensional column vector pᵢ is used for representing a position of an i^{th} agent in a two-dimensional world coordinate system, and \dot{p}ᵢ is a first-order derivative of the position of the i^{th} agent; and u is a linear velocity of the agent, which is also a control input of the system, and a two-dimensional column vector uᵢ is used for representing a velocity of the i^{th} agent in the two-dimensional coordinate system;
the zero-crossing barrier function h is:
h(pᵢ−pⱼ)=∥pᵢ−pⱼ∥₂−Dₛ;
wherein, Dₛ=D₀+Rₛ is a constant, D₀ is an expected safe distance between two agents, Rₛ is a safety margin added to ensure robustness, i,j∈1, . . . , N, i≠j, N is a total number of agents in a swarm, a symbol ∥⋅∥₂ represents a two-norm of a vector, and pⱼ represents a position of a j^{th} agent;
the generating the safety constraints based on the candidate zero-crossing barrier function, comprises:
differentiating the zero-crossing barrier function with respect to time t to obtain a safety constraint g as follows:
$${g}_{ij} ( {t}_{k} ) = \frac{{( {p}_{i} ( {t}_{k} ) - {p}_{j} ( {i}_{k} ) )}^{T}}{{‖ {p}_{i} ( {t}_{k} ) - {p}_{j} ( {t}_{k} ) ‖}^{2}} ( {u}_{i} - {u}_{j} ) + γ ( h ( {p}_{i} ( {t}_{k} ) - {p}_{j} ( {t}_{k} ) ) \geq 0 ;$$
wherein, γ is a decay rate of the barrier function, which is a constant greater than 0; and tₖ is sampling time, and u is the control input, u={u₁, u₂, . . . u_{N}};
a specific method for the agent to update the control input and a relevant constraint variable thereof locally comprises:
initializing an initial value λ⁰ of the constraint variable, and solving for an inner-layer control input
$${u}_{i}^{m} ( {t}_{k} )$$
i∈1, . . . , N;
$${u}_{i}^{m} ( {t}_{k} ) = a = {arg min}_{{u}_{i}} {‖ {u}_{i} - {v}_{i}^{*} ( {t}_{k} ) ‖}^{2} + {\sum }_{j ∈ {N}_{i}} {λ}_{ij}^{m} ( {t}_{k} ) {A}_{ij} ( {t}_{k} ) {u}_{i} m = 0 , … , M ;$$
wherein,
$${v}_{i}^{*}$$
∈ [symbol] ² is a nominal control input, which provides a reference value of velocity for the i^{th} agent;
updating an outer-layer constraint variable
$${λ}_{ij}^{m + 1}$$
i≠j∈1, . . . , N by a gradient ascent method;
$${λ}_{ij}^{m + 1} ( {t}_{k} ) = {[ {λ}_{ij}^{m} ( {t}_{k} ) + \frac{1}{{W}_{ij} ( {t}_{k} )} ( {A}_{ij} ( {t}_{k} ) {u}_{i}^{m} ( {t}_{k} ) + {A}_{ji} ( {t}_{k} ) {u}_{j}^{m} ( {t}_{k} ) - {b}_{ij} ( {t}_{k} ) ) ]}_{{R}^{+}} ;$$
wherein, Wᵢⱼ(tₖ) depends on numbers Nᵢ(tₖ) and Nⱼ(tₖ) of other agents within neighborhoods of the agents i and j at the time tₖ, and is defined as follows:
Wᵢⱼ(tₖ)=Nᵢ(tₖ)+Nⱼ(tₖ);
letting
$${v}_{i} ( {t}_{k} ) = {u}_{i}^{M} ( {t}_{k} ) ,$$
wherein M is a maximum number of iterations limited by a network communication delay.

2. The distributed cooperative safety-critical control method for the multi-agent system according to claim 1, wherein the loss function is:
$$f ( u ) = {\sum }_{i = 1}^{N} {‖ {u}_{i} - {v}_{i}^{*} ( {t}_{k} ) ‖}^{2} .$$

3. A computer-readable storage medium, storing a computer program, wherein the computer program, when executed by a processor, implements the distributed cooperative safety-critical control method for the multi-agent system according to claim 1.

4. A storage device, comprising a storage medium and a processor, the storage medium storing a computer program, wherein the processor, when executing the computer program, implements the distributed cooperative safety-critical control method for the multi-agent system according to claim 1.
